(19) United States
(12) Patent Application Publication
(10) Pub. No.: US 2007/0118358 A1
(43) Pub. Date: May 24, 2007

(54) PHRASE PROCESSOR

(76) Inventor: Alexander S. Tom, Cupertino, CA (US)

Correspondence Address: LOWE HAUPTMAN BERNER, LLP, 1700 DIAGONAL ROAD, SUITE 300, ALEXANDRIA, VA, 22314, US

(21) Appl. No.: 11/557,940

(22) Filed: Nov. 8, 2006

Related U.S. Application Data
(60) Provisional application No. 60/734,288, filed on Nov. 8, 2005.

(51) Int. Cl. G06F 17/28; G06F 17/21

(52) U.S. Cl. 704/10; 704/3

(57) ABSTRACT

A method of implementing a grammar in hardware processing is described. The method comprises determining a delineation of one or more terminals in a received string; assigning one or more non-terminals to one or more of the one or more terminals, wherein the one or more non-terminals belong to a grammar and are stored in a symbol table; reducing the one or more non-terminals to one or more reduced non-terminals symbols based on a set of reduction rules; producing one or more leaf non-terminals based on at least one of the one or more reduced non-terminals and a set of production rules; and generating actions and data as a result of the actions based on the production rules used to produce the one or more leaf non-terminals and based on the delineation of the received string.

### CLAIM OF PRIORITY UNDER 35 U.S.C. §119

The present Application for Patent claims priority to Provisional Application No. 60/734,288 entitled “PROGRAMMABLE HARDWARE DIGITAL GENERAL PURPOSE PHRASE PROCESSOR” filed Nov. 8, 2005 and which is hereby expressly incorporated by reference herein.

### FIELD

The disclosed embodiments relate to a phrase processor.

### BACKGROUND

Classical computing theory treats formal algorithmic implementation through the use of language theory. This has become the basis for programming contemporary computing implementations from microprocessors to digital signal processors. Many applications for which microprocessors are programmed do not need the arithmetic functionality or the extremely fine granularity of most microprocessors. In effect, many applications do not need a general purpose computing device capable of implementing all languages permissible by theory.

The set and type of languages actually used in common implementations is only a small subset of potential languages known. This is reflected in many architectural approaches for microprocessors where attempts to customize the architecture through microcode to implement assembly level instructions to complex instruction set using a large variety of assembly language instructions and very large instruction word architectures.

The microprocessor, whether based on a von Neumann or Harvard architecture, is a very fine level of granularity type of Turing machine. In order to execute any decision structure, the instructions representing the decision at a particular given point must be read from memory, decoded, and executed and for binary decisions this is fairly efficient. For multiple decisions, N-1 comparisons may be required for N decisions. For selecting among multiple rules in a grammar, this can be relatively slow. Consequently, processor architectures used in Language Technology applications such as Information Retrieval, Agent Technology, Natural Language Processing, Artificial Intelligence, Bioinfomatics, Computer Language Interpreters, Speech Processing, Planning and Scheduling, Network Processing, Network Security, and Knowledge Representation processing, exhibit performance that tends to be constrained far below the available communications channel capacity for networking and storage.

### DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a simplified block diagram of a hardware lexical scanner (HLEX), a production subsystem, and a reduction subsystem portion of a phrase processor chip according to an embodiment;

FIG. 2 is a block diagram showing an example of processes as they go through the HLEX, the reduction subsystem, and production subsystems;

FIG. 3 is a simplified block diagram of the reduction subsystem according to an embodiment;

FIG. 4 is a simplified block diagram of the symbol table exchange structure according to an embodiment;

FIG. 5 is a simplified block diagram of the production subsystem;

FIG. 6 is a simplified block diagram of the production state machine according to an embodiment;

FIG. 7 is a simplified block diagram of a terminal string generator switch according to an embodiment; and

FIG. 8 is a simplified block diagram of a method of implementing a grammar in hardware processing.

### DETAILED DESCRIPTION

By designing an implementation specifically to implement a subset of languages and to process data as a language processor, efficiency improvements may be obtained instead of using hardware capable of implementing all languages and having to re-map algorithms implemented in language back into the generic language hardware implementation. The hardware implementation embodiments may each define a set of grammars that may be used to implement an application that performs data processing.

The phrase processor has a novel method for processing message formats or frames at a line rate by assigning abstract symbols to fields permitting rapid application of rules concerning classification, forwarding, and inspection. In this context, line rate is the ability to complete the reduction stage or production stage of the phrase processor for a given data frame or message before the next message or data frame of the same processing requirement arrives.

The new approach to implementing general algorithms specific to a subset of non-arithmetic languages is described. In some embodiments, the approach is implemented in digital form in hardware, e.g., a processing device. The phrase processor is specifically designed to implement common languages in use today to process structured data, in message packets or block form, such as network frames and protocol data units, in terms of parsing, by recognizing strings and fields within the structured data at different messaging protocol layers and associating a semantic meaning to the strings, to drive a given state machine for an algorithm and determine consequential actions for them. By assuming such languages are to be used, the fundamental Turing machine model of fetch-decode-execute cycle of the conventionally implemented computer based on the Turning machine model can be eliminated. By treating each of the fields and strings as elements of a grammar, a transformed grammar is created whose rule reductions are programmed into memory and executed by hardware. For relevant fields of a packet, the hardware applies appropriate rules and performs rule reductions according to the grammar. The final rule reduction(s) is then used for semantic processing. Semantic actions are associated directly from the rule through a decoder or by use of a more complex state machine which, in an embodiment, is specified through a separate set of rule productions. The productions specify the semantic equivalent for the fields and strings which were on the reduction side, either in the ordering of sequence or a specified mapping. The result is response messages, processed structured data blocks, network frames, or protocol data units. All of which may be implemented in conventional chip technology.

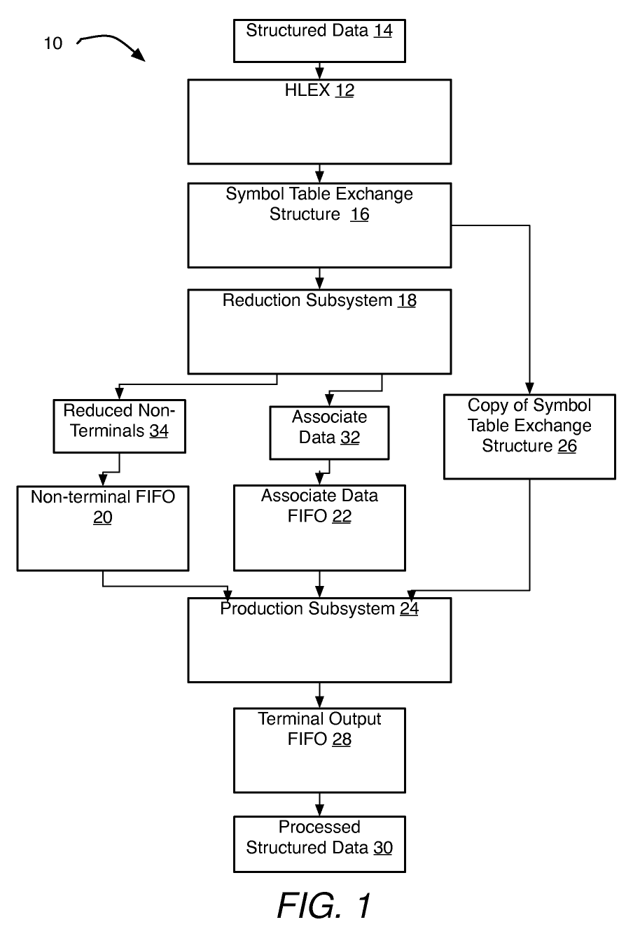

FIG. 1 depicts a high level functional block diagram of a phrase processor system 10, according to an embodiment referred to as phrase processor 10. In some embodiments, the phrase processor system 10 is implemented on a chip. The phrase processor 10 comprises a hardware lexical scanner (HLEX) 12, which receives incoming structured data 14 such as protocol data units (PDUs), messages, and data blocks and identifies strings within them called terminals and places the strings into a symbol table exchange structure 16 thereby assigning predefined symbols belonging to a grammar to recognized terminals. The string of terminal symbols is then used by the reduction subsystem 18 to map the terminal symbols according to predefined rules of the grammar comprising non-terminal symbols and terminal symbols or evaluate the terminal symbols to determine if they meet user-defined conditions and representing that as a non-terminal symbol, then the reduction system 18 matches the terminal and non-terminal symbol representations to a sequence of non-terminal symbols representing a rule of the predefined grammar. The final non-terminal or set of non-terminals may represent the intent or acceptability of the terminal strings overall. The reduced non-terminals 34 or set of reduced non-terminals 34 is sent to a non-terminal FIFO (First In First Out) 20, along with associate data 32 related to a messaging session retrieved during the reduction for processing which is also placed into an associate data FIFO 32. The non-terminal FIFO 20 is used by the production subsystem 24 to generate terminal symbols, by applying non-terminal symbol rules as a template, which may represent the structure for the structured data 14. The production subsystem 24 replaces the terminal symbols with the actual terminals from the associate data FIFO 32 if a session was involved and from a copy of symbol table 26. The production subsystem 24 then copies the final terminal strings in order out to the terminal output FIFO 28, where the processed structured data 30 is then available.

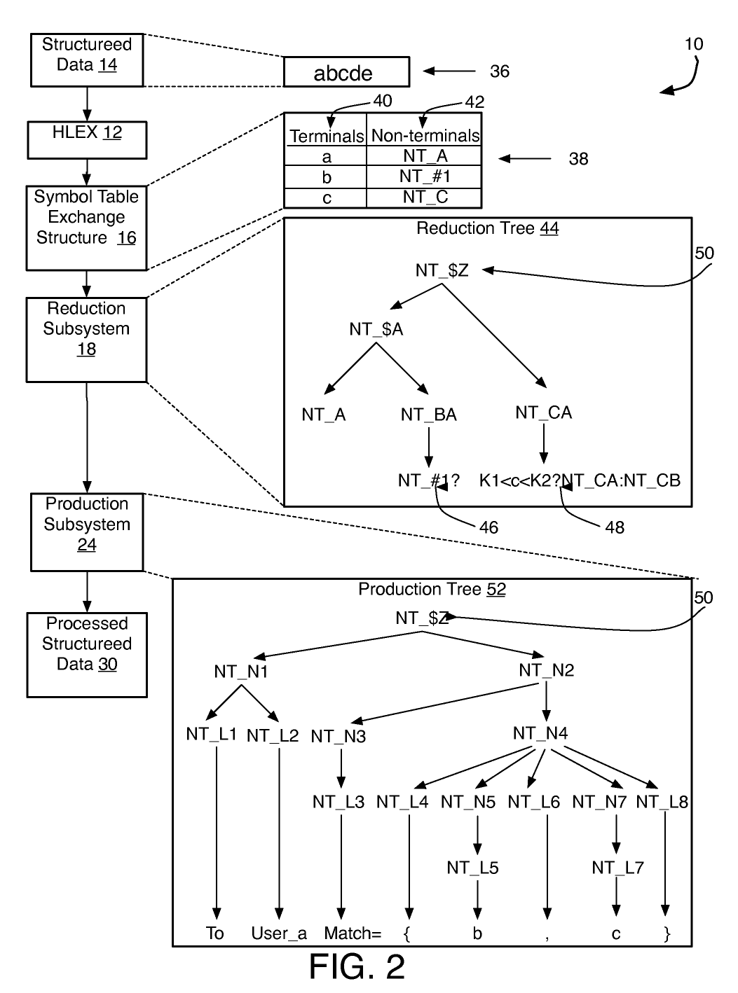

FIG. 2 depicts a detailed view of the above-described processes. In the FIG. 2 example, the structured data 14 is a string 36 with value “abcde” transmitted to the phrase processor system 10. The HLEX 12 subsystem parses the string 36 “abcde” and determines what is a terminal symbol 40 and enters the terminal symbols into the symbol table exchange structure 16 along with readily identifiable non-terminal symbols 42 such as “NT_A” which is the non-terminal symbol 42 for “a” according to a predetermined grammar. Here, only a portion of the symbol table exchange structure 16 is illustrated as a simple symbol table 38. Unidentified terminals such as “b” are assigned an unknown non-terminal symbol such as “NT_{—}#1?”. Where “NT_{—}#1?” represents that the terminal “b” was not found in the predetermined grammar, which the phrase processor 10 is implementing. The HLEX 12 continues identifying and assigning the contents of the structured data 14, here the string 36, until reaching the end of the string 36.

Next, the reduction subsystem 18 processes the non-terminals 42, depicted in reduction tree 44, by reading the symbol table exchange structure 16, here the simple symbol table 38, and attempting to match a symbol table exchange structure 16 entry to the reduction tree leafs, “NT_A”, “NT_BA”, and “NT_C”, which are predefined by the grammar. The non-terminal symbol, “NT_C”, is dependent upon a condition 48, here “K1<c<K2?”, of the terminal “c”, so the reduction subsystem 18 evaluates the condition “is K1<c true?” and “is c<K2 true?”. Here both are true, so the reduction subsystem 18 assigns a predetermined non-terminal NT_CA to the non-terminal symbol “NT_C”, which was dependent on condition 48, writing the evaluation into the symbol table exchange structure 16.

Having the non-terminals “NT_A” and “NT_CA,” the production subsystem 24 then infers that “NT_{—}#1?” 46 is the non-terminal “NT_BA” as “NT_BA” is the only matching non-terminal symbol of the predetermined grammar that the phrase processor system 10 is implementing. The ability to determine by context how to classify an unidentified terminal string, here “NT_{—}#1?” 46, is very powerful, as the ability allows the phrase processor subsystem 10 to manage and process previously unidentified or undefined strings, here “b”. Further, the phrase processor subsystem 10 can be configured to recognize strings within larger strings and assign those strings to non-terminals, using the same type of inference from the use of the rules of the grammar. The ability to recognize strings within larger strings permits not only fixed frame processing, but also frame processing to occur at multiple layers deep for very deep layers where strings may be of arbitrary length and of many variable content. The phrase processor's ability to identify strings of arbitrary length and determine the role the string plays in an upper level message such as a command, data string, or type identifier through an inference approach or context sensitive approach, is crucial for applications in mark up languages and higher level languages which are being used for internetworking communication as a standard such as HTML, SGML, XML, and SOAP. This ability to infer a classification for strings within larger strings permits embodiments of phrase processor to implement applications for classifying and filtering and be able to recognize and forward frames based on criteria in not only L2 to L4 but also L5 to L7, and above.

Continuing, the reduction subsystem 18 then matches the non-terminal symbols to reduction rules which are part of the predetermined grammar representing an application such as “NT_A*NT_BA=>NT_$A” and generates the non-terminal symbol “NT_$A” and then again matching the rule “NT_$A*NT_CA” =>NT_$Z” to generate the non-terminal symbol “NT_$Z” 50 as the final reduction result.

The non-terminal “NT_$Z” 50 is then passed on to the production subsystem 24 which uses a set of production rules which are part of the predetermined grammar that the phrase processor system 10 implements. A production tree 52 depicts the application of production rules to obtain the correct response. In this case, the non-terminal symbol “NT_N$Z” produces a number of internal node non-terminals such as “NT_N1, NT_N2, NT_N3” and “NT_N4”. These productions continue until the leaf non-terminals are reached such as “NT_L1, NT_L2, NT_L5” and “NT_{—L}7”. At this point, the production subsystem 24 matches the leaf non-terminal symbols to terminal strings, here “To”, “User_a”, “Match=”, “{”, “b”, “,”, “c”, “}”, which are either pre-defined or defined in the symbol table exchange structure 16 as a result of the structured data 14 being processed by HLEX 12.

A typical end result from the production subsystem 24 in response to processing a non-terminal 50 is a response such as a message for a protocol state machine, the result of a search, or a translation.

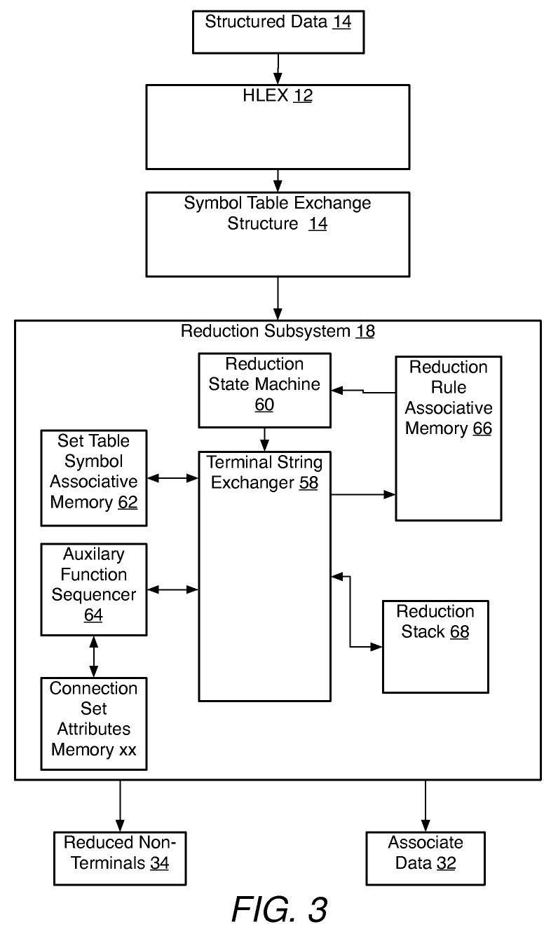

FIG. 3 depicts HLEX 12 and a detailed view of the reduction subsystem 18 of FIG. 1 and FIG. 2. Incoming structured data 14 such as a frame is read by the HLEX 12 which segments the frames into fixed fields depending upon the contents of given fields and assigns the fields to a generic class or a non-terminal symbol according to the grammar that the phrase processor system 10 is implementing.

The rules of the grammar being implemented by the phrase processor system 10 may specify a class and may require immediate evaluation or not. Non-terminals may be assigned to a particular class. For instance, we may assign the non-terminal “NT_$COLOR1” to “blue” and “NT_$COLOR2” to “red”, and assign both “NT_$COLOR1” and “NT_$COLOR2” to the class “COLOR”. This provides a way to generalize a rule making it easier to match a class of terminals. The rules in the grammar can be written then to match with either of the instantiations. The rules in the grammar may also require that the non-terminal be evaluated before matching. Some non-terminals such as “$TIME” may be recognized as a time stamp and not evaluated until after being processed by the reduction subsystem 18.

The HLEX 12 can assign a token, which is a part of a string, to a non-terminal or a class based on three things, (1) the relative position of the token in the input string, for example a grammar may define a packet, (2) the token being a “reserved word or symbol” defined by the grammar, and (3) based on a “reserved string” defined by the grammar.

The HLEX 12 writes the non-terminal or the class value and the token into the symbol table exchange structure 14. The symbol table exchange structure 14 can be used to look up the actual literal string “terminal” which corresponds to a leaf non-terminal. However some reserved keywords or symbols such as “http”, “://”, “https”, or “ftp” can be pre-defined by the grammar and permanently loaded into the symbol table exchange structure 14.

The generic classes, i.e., non-terminals, and the exact contents are then passed into a symbol table exchange structure 14 which in some embodiments is a dual port memory structure permitting the HLEX 12 to write to the symbol table exchange structure 14 while the terminal string exchanger 58 is permitted to read from the symbol table exchange structure 14. The HLEX 12 continues processing the incoming structured data 14 until the entire structured data 14 has been processed. When the first element of the symbol table exchange structure 14 is written for a new frame the reduction state machine 60 resets to an initial state and begins rule reductions sequences to drive the terminal string exchanger 58.

The reduction state machine 60 drives the terminal string exchanger 58 to exchange classifications arriving through the symbol table exchange structure 14 into non-terminals. Non-terminals are elements of the alphabet which belong to the grammar that was used to generate the rules of the phrase processor system 10 and specific patterns of non-terminals form rules of the grammar. The terminal string exchanger 58 reads out symbols from the symbol table exchange structure 14 and uses those to “look” up other items such as a set table symbol associative memory 62, to determine whether a symbol belongs to any defined types of sets, or perform operations with an auxiliary function sequencer 64 to determine non-terminals representing the result of various temporal or comparative functions. The terminal string exchanger 58 is driven by the reduction state machine 60. The reduction state machine 60 is driven by the reduction rule state which is provided by a reduction rule associative memory 66. Classification, filtering, and search rules specified by the user are parsed, e.g., by software, and a corresponding set of reduction rules is created which is downloaded to reduction rule associative memory 66 prior to operation. The reduction rules are decoded by the reduction state machine 60 and presented to the reduction rule associative memory 66 for a determination of what terminal classification to non-terminal exchange should take place. After retrieving or converting one or more terminals to a non-terminal, the terminal string exchanger 58 uses the non-terminals to compose a new lookup string which is presented to the reduction rule associative memory 66. The reduction rule associative memory 66 then looks up the matching rule and presents the resulting production to the reduction state machine 60 to drive the next state.

Resulting rule reductions are stored on the reduction stack 68 to thereby enable rule reduction attempted classifications to take place until the full rule patterns above a given rule reduction attempt are completed in instances where the exact class of the terminal and corresponding non-terminal assignment is unclear. If a determination results that no such rule structure exists for a given classification, the reductions are backtracked using the stack which allows sentential forms which are not as context sensitive to be recognized by a grammar implemented by the rule reductions. The reduction stack 68 permits grammars with ambiguities to discern a pattern from an internal node. For instance, classes “NT_$NUMBER” or “NT_$STRINGS”.

A series of rule reductions for the structured data 14 such as a frame, structured block of data or PDU, are passed on the production subsystem 24 which indicates the intent of the frame or data and what should be done with the frame or data. In addition to rule reductions, auxiliary information from the connection set attributes which contains information of data across multiple message sessions is retrieved and sent to the production subsystem 24 for further processing.

The reduction subsystem 18 also determines the semantic intent of structured data 14 such as a string within multiple layered structured data 14 such as a frame whose data such as strings are not contained within fixed fields and are inferred by the context of the surrounding fields or strings. This is useful in determining the higher layer message contents and what the contents drive higher layer protocol state machines to do, and as to whether the state transitions caused by the structured data 14, such as messages, would be valid.

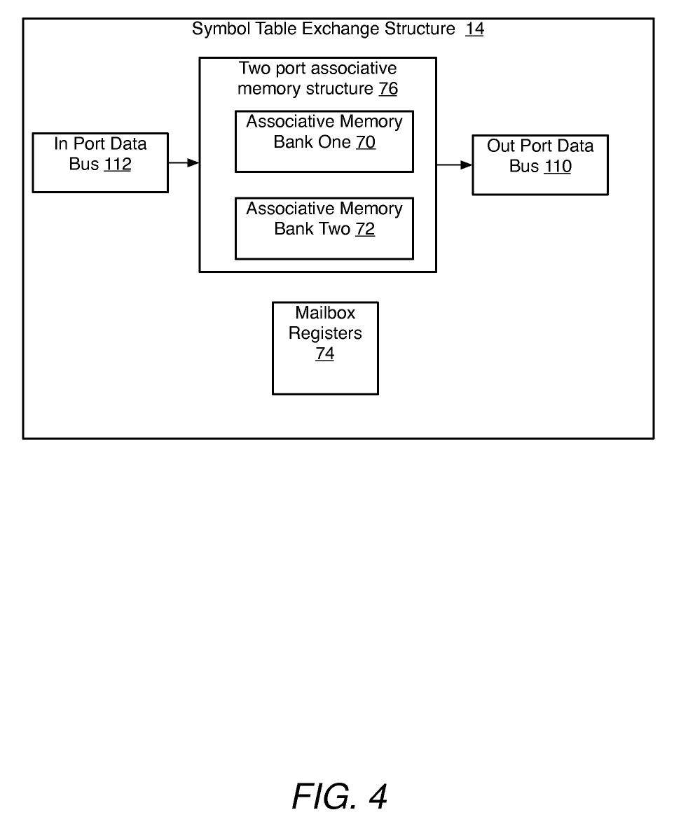

FIG. 4 depicts a high level functional block diagram of the symbol table exchange structure 14. The symbol table exchange structure 14 consists of a two port associative memory structure 76 comprised of associative memory bank one 70 and associate memory bank two 72 and a set of mailbox registers 74. The two port associative memory structure 76 provides a quick way for the terminal string exchanger 58 to obtain a certain class and begin conversion to a non-terminal or find a non-terminal that has already been identified by the HLEX 12. The mailbox registers 74 are for known classes and have the associated classes or non-terminals at predefined register addresses. Two port associative memory structure 76 permits free form classes and non-terminals to be found quickly by the terminal string exchanger 58. In an embodiment, two port associative memory structure 76 can be used to find non-terminals through an associative search. The ability to find non-terminals with an associative search enables recursive descent matching.

The purpose of the terminal string exchanger 58 is to exchange equivalent terminals or classes with non-terminal representations. In some embodiments, the terminal string exchanger 58 is a hardware switch. Classes, although a generic representation of a terminal, may not be the proper categorization into a non-terminal which belongs to the grammar. However, classes facilitate quick identification or conversion to the proper non-terminal symbol. Non-terminal symbols are elements of the alphabet of a grammar created to implement reduction rules which implement an algorithm such as access control rules. The terminal string exchanger 58 is the primary data path for operations consisting of a terminal string exchanger 58. The terminal string exchanger 58 permits pathways to be switched between the symbol table mailbox registers 74, symbol table exchange structure 14, two port associative memory structure 76, the auxiliary function sequencer 64, the reduction stack 68, and the reduction rule associative memory 66. The terminal string exchanger 56 is controlled by the reduction state machine 60.

A purpose of the reduction state machine 60 is to configure the control signals to the symbol table exchange structure 14 to switch terminators or classes from the symbol table exchange structure 14, two port associative memory structure 76, or auxiliary function sequencer 64, reduction stack 68, and non-terminals from the symbol table exchange structure 14, or reduction rule associative memory 66. In addition, the reduction state machine 60 determines whether to use the current reduction rule or a past reduction, from the reduction stack 68, to the reduction rule associative memory 66.

The reduction state machine 60 is a fixed set of finite state machines which follow a fixed set of states depending upon the current reduction rule. The reduction state machine 60 is configured for the grammar that the phrase processor system 10 is implementing. Each state has the intent of converting a terminal or class to a non-terminal by setting the control signal configuration (not illustrated) of the terminal string exchanger 58. The state of the reduction state machine 60 is driven to the next state by a matching reduction rule which causes a state decoder of the reduction state machine 60 to drive the terminal string exchanger 56 selection for inputs to outputs and the multiplexers for the set table symbol associative memory 63 result or symbol table exchange structure 14 and the current reduction rule or a past reduction rule.

A function of the auxiliary function sequencer 64 is to evaluate terminal conditions and represent the status as non-terminals. Examples of non-terminal results are functions such as keeping track of numbers, storing and comparing states in a state machine instantiation, the time and date structured data is being examined as well as the duration of a session or retrieving connection set attributes. The auxiliary function sequencer 64 evaluated non-terminals and terminals are written to function mailbox registers (not illustrated.) Results are reflected in a flag register (not illustrated) and the non-terminal symbol encoder (not illustrated) converts the flag (not illustrated) to a defined non-terminal belonging to the grammar's alphabet. Results may also be written back out to the function mailbox registers to be passed onto the production subsystem 24.

The flow of the reduction subsystem 18 for the phrase processor system 10 is now described. Prior to the structured data 14, for example a string that is an incoming frame, the reduction state machine 60 returns to an initial start state. From this state, after the terminal string exchanger 58 is configured based on the rule pattern and reduction rule, a new frame or structured data block is received and written to the symbol table exchange structure 14 by the HLEX 12 and the reduction state machine 60 is driven to the next state as the new frame or block of the structured data 14 is a transitional event. Otherwise, the reduction state machine 60 is driven to the next state primarily through two events: (1) discovery of a reduction pattern rule; and lack of discovery of a reduction rule.

As the initial tokens are written to the mailbox registers 74 of the symbol table exchange structure 14, the tokens are flagged as immediately available to the terminal string exchanger 58. For predefined frame types of the structured data 12, terminals are already assigned to non-terminals before being written to the symbol table exchange structure 14. The terminal string exchanger 58 then reads out the tokens and writes any well known non-terminals to the reduction rule associative memory 66. Terminals which aren't readily apparent are passed to the set table symbol associative memory 62 or the auxiliary function sequencer 64 for a determination of the associated non-terminal. The initial start state non-terminal is also written to the reduction rule associative memory 66.

The concatenated non-terminals transferred to the reduction rule associative memory 66 are then used to search the reduction rule associated memory 66 for a matching non-terminal pattern. When the proper reduction rule pattern is found, the rule number is returned (a process which is termed a reduction, and which is used for the next reduction and may also be pushed onto the stack). Not every reduction rule pattern requires multiple non-terminals whose source is from the terminal string exchanger 58. Reduction rules may consist of multiple non-terminals from the reduction stack 68.

If the non-terminal is a stopping non-terminal, i.e. a non-terminal which represents a decision or the semantic identification of a sentential or block structure, the reduction state machine 60 recognizes the halting pattern, from being configured with the grammar, and stops and makes the reduced non-terminals 34 available through the non-terminal FIFO 20 or encodes the pattern for signaling to the external world.

If as part of the structured data 14 deeper layered frames, data structures, or further associations or operations are required, the entire sequence starting from the transfer of terminals from the symbol table exchange structure 14 to the set table symbol associative memory 62 or auxiliary function sequencer 64 can be repeated. By the operation of the reduction state machine 60. In this way for a number of sessions a state machine of protocols or layered applications of the reduction state machines 60 may be followed. This also provides a means for the identification of unidentified strings that the HLEX 12 was unable to parse to tokens of finer granularity. These may be reduced and identified through contextual position of known non-terminal pattern rules. This permits arbitrary strings which may represent hosts, directories, files, commands, or scripts to be inspected.

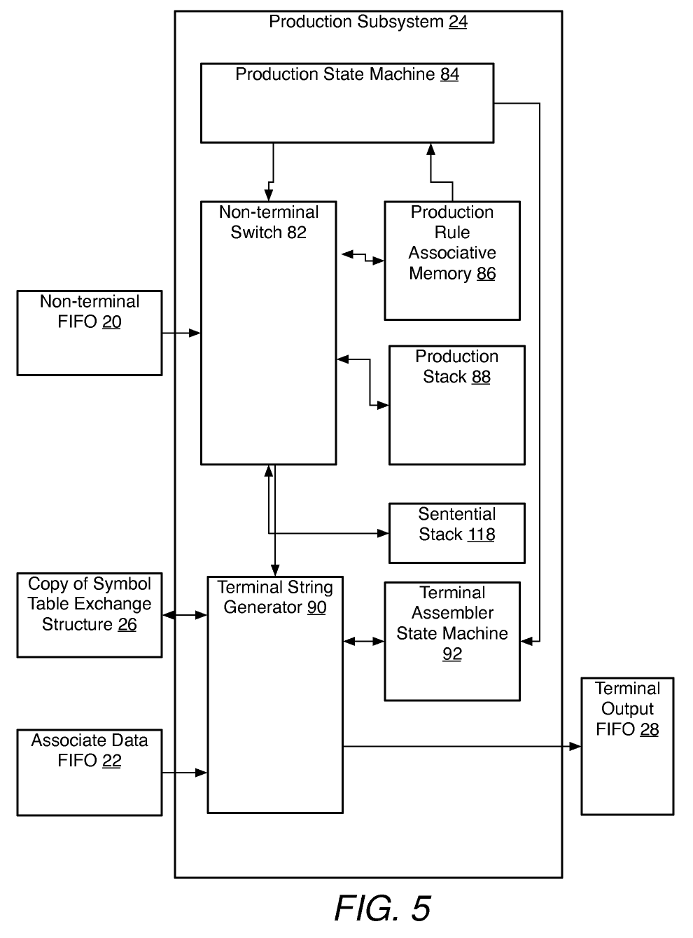

FIG. 5 depicts a block diagram of the production subsystem 24 of FIG. 1 in which a reduced non-terminal symbol, for example “NT_$Z” 50 of FIG. 2, is retrieved from the non-terminal FIFO 20 and is switched through the non-terminal switch 82 and used by the production state machine 84 to look up the matching production rule from the production rule associative memory 86. There are two types of non-terminals of the grammar used to construct the phrase processor 10 recognized, root non-terminals and leaf non-terminals. Root non-terminals are re-applied to look up another production rule from production rule associative memory 86 and intermediate root non-terminals are pushed onto the production stack 88 if more than one non-terminal production is below the non-terminal. Leaf non-terminals are passed onto the terminal string generator 90. Root non-terminals are discarded when all of the lower non-terminals have reached their leaf non-terminals. The process of re-applying root non-terminals to look up more production rules ends when there are no more root non-terminals.

The terminal string generator 90 is a multiplexed input register used to replace leaf non-terminals symbols with the actual terminal strings. The terminal string generator 90 multiplexer, copy of symbol table exchange structure 26, and the associate data FIFO 22 is driven by the terminal assembler state machine 92.

The non-terminal switch 82 is used by the production state machine 84 to obtain the reduced non-terminal from the reduction subsystem 18 to perform either a syntax directed translation or a semantic derivation of non-terminal sentences. The process begins by reading reduced non-terminals out of the non-terminal FIFO 20 and into the non-terminal switch 82. The reduced non-terminal is looked up in the production rule associative memory 86 and the associated productions are retrieved and non-terminals within them are identified according to either a leaf non-terminals or node non-terminals. Sentences with node non-terminals, i.e., sentences requiring additional expansion, are sent back to be looked up again in production rule associated memory 86 and are placed into the production stack 88 for back tracking capability. Resulting productions, referred to as sentences or phrases, are pushed onto the sentential stack 118 along with the number of non-terminal symbols making up the sentence onto the length stack (not illustrated.) When a sentence consisting only of leaf non-terminals is produced, this is indicated to the production state machine 84 to pop the sentences off of the production stack 88. Node non-terminals are discarded. In this way, node non-terminals are produced until reaching leaf non-terminals and sent to the terminal string generator 90. When the sentential stack 118 and production stack 88 are completely emptied then the next reduced non-terminal symbol from the reduction subsystem 18 is processed.

The production rules are created in such a way that the production rules are deterministic and able to reach a full sentence of leaf non-terminal symbols without arbitrary productions.

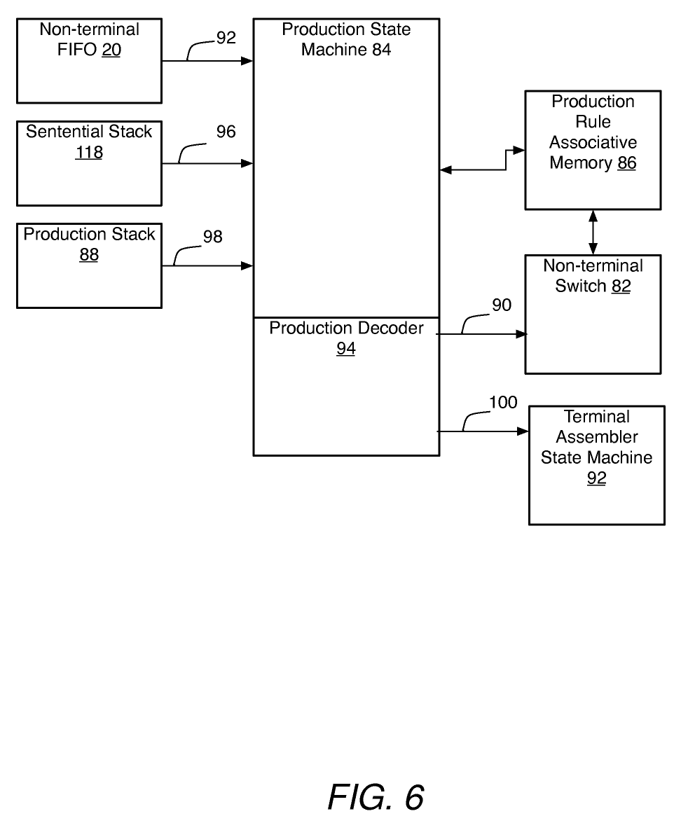

FIG. 6 depicts a simplified block diagram of the production state machine 84 of FIG. 5. A purpose of the production state machine 84 is to configure the control signals 90 to the non-terminal switch 82 to derive non-terminal sentences from production rules in production rule associative memory 86. The production state machine 84 starts from an initial state after detecting a reduced non-terminal from the status 92 of the non-terminal FIFO 20. The production state machine 84 then proceeds through a series of non-terminals which when decoded by the production decoder 94 provides switching configurations to lookup the node non-terminals switch 82 from the non-terminal FIFO 20, the production stack 88, or the output of the production rule associative memory 86.

When the status 96 of the sentential stack 118 indicates that a node non-terminal symbol is in the sentence, the production state machine 84 configures the non-terminal switch 82 to place the node non-terminal symbol on the production stack 88 and use the symbol to derive the production rule associative memory 86. When the status 96 of the sentential stack 118 indicates that there are no node non-terminal symbols in a sentence, the production state machine 84 begins executing a series of states intended to pop the leaf non-terminals, the number of which at each level of the production stack 88 is indicated by the stack length, off of the sentential stack 118 to the terminal assembler state machine 92. After receipt of signals 96, 98 that the sentential stack 118 and production stack 88 are empty, the production state machine 84 returns to the final state and the production decoder 94 transmits a signal 100 to the terminal assembler state machine 92. The production state machine 84 then proceeds to the idle state to await a new reduced non-terminal symbol from the non-terminal FIFO 20.

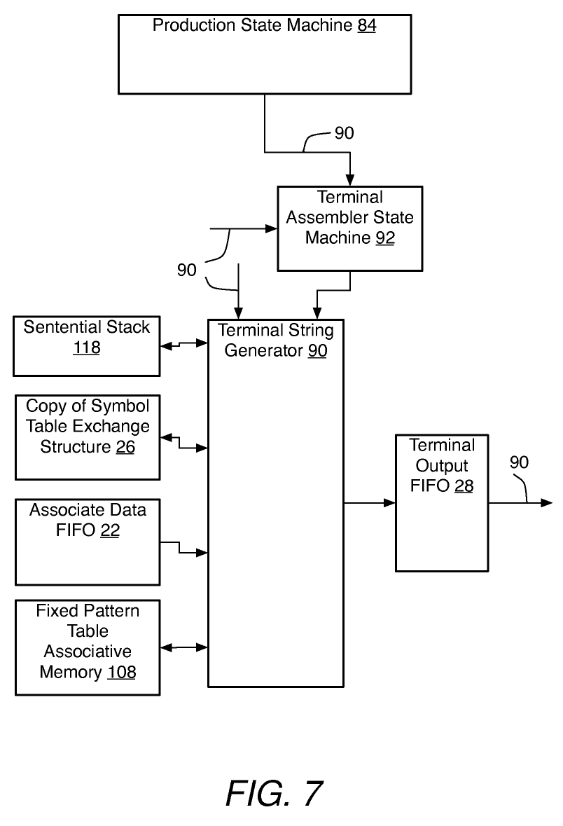

FIG. 7 depicts a high level block diagram of the terminal string generator switch 102, the terminal assembler state machine 92 which drives the terminal string generator 102, and copy of symbol table exchange structure 26, associate data FIFO 22, fixed pattern table associative memory 108 connected with the terminal string generator 102. The terminal assembler state machine 92 takes leaf non-terminals and uses them to look up the actual terminals in the fixed pattern table associate memory 108 or the copy of symbol table exchange structure 26 and switches those terminals to the terminal output FIFO 28. Some leaf non-terminals are simply copy placeholders indicating associate data is copied from the associate data FIFO 22 to the terminal output FIFO 28.

The flow of the production subsystem 24 for the phrase processor system 10 is now described. Prior to processing a reduced non-terminal (NT) symbol, the production state machine 84 returns to an initial state either as part of startup, e.g., chip power up, or when a new NT symbol is detected from the non-terminal FIFO 20 to the production rule associative memory 86. Once the reduced NT symbol is in the production rule associative memory 86, the production state machine 84 uses the symbol as a key to search production rule association memory 86. The production rule association memory 86 is searched with two types of symbols: (1) node NT symbols, which correspond to nodes in a production tree and (2) leaf NT symbols which have direct correlations to terminals.

The node NT symbol alone or in a combined concatenation with leaf NT symbols form a pattern. If a match with the node NT symbol or pattern is found, the production rule is read out of the production rule associated memory 86 and leftmost symbol is checked to see if the rule is a node NT symbol or a leaf NT symbol. If the leftmost symbol is a node NT symbol, the production sequence is placed onto the production stack 88 and expansion begins on the node NT symbol. The leaf NT symbols and node NT symbols are used to again search production rule associated memory 86. This process of expansion of node NT symbols continues until only leaf NT symbols are read out of the production rule associated memory 86. If only leaf NT symbols are read out, then the leaf NT symbols read out of production rule association memory 86 and the leaf NT symbols are popped off the sentential stack 118 and copied to the terminal string generator switch 90. The process continues until the sentential stack 118 is empty.

After the sentential stack 118 is empty, the production stack 88 is checked for remaining unexpanded node NT symbols. If unexpanded node NT symbols remain, the cycle of expansion with the production rule associated memory 86 is performed.

If the production stack 88 is empty, then the production state machine 84 returns to the idle state and thereby signals the terminal assembler state machine 92 to begin matching leaf NT symbols to the copy of symbol table exchange structure 26 and fixed pattern table associate memory 108 by copying the associated terminals from matches through the terminal string generator switch 102. If the leaf NT symbol is an associate data type NT symbol, then a terminal string is copied from the associate data FIFO 22. The process continues until leaf NT symbols are converted into terminal strings and copied to the terminal output FIFO 28.

The production stack 88 exists to permit exploratory productions to take place so that if, during the course of a production sequence, there are multiple production rules which may match, production attempts are made and backtracked if necessary if a determination is made that the improper production rule was attempted. To support this capability, whenever a production rule is read and the leftmost terminal symbol is checked as to whether the symbol is a node symbol, the symbol is pushed onto the production stack 88 as the production rule is pushed onto the sentential stack 118. If the production sequence is found to not be the one desired, no production rules match, and the node NT symbol is popped off the production stack 88. If the production stack 88 is not empty, the prior node NT symbol from the one currently being attempted to be expanded upon is popped off the stack, written to the production rule associative memory 86 with a tag to prevent the production rule from being selected again, and a new production expansion is attempted based on the prior NT symbol.

A typical end result is a response such as a message for a protocol state machine, the result of a search, or a translation. The production subsystem 24 may produce an action based on these non-terminal reductions. The production subsystem 24 may generate an action and data and message formats. The new data or message formats are transmitted to the processed structured data 30

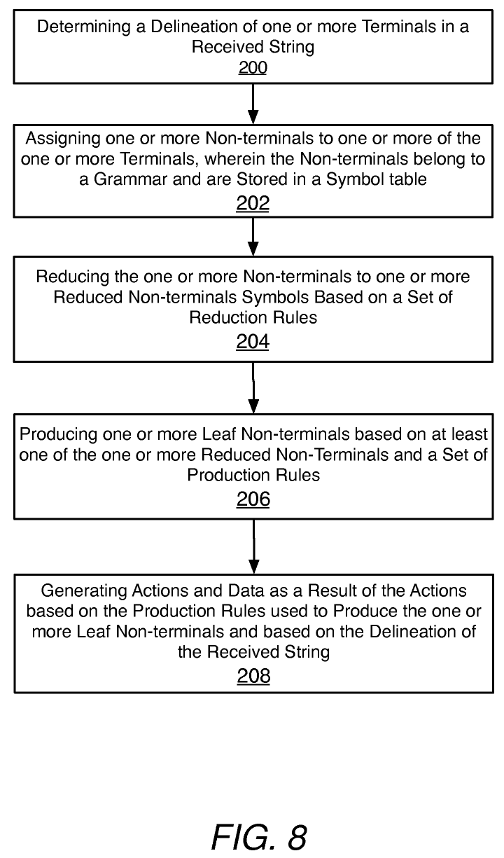

FIG. 8 depicts, an embodiment of a method of implementing a grammar in hardware processing, comprising determining a delineation of one or more terminals in a received string (BLOCK 200). In an embodiment, HLEX 12 is configured for a grammar and finds the delineations of terminals within the received string. The flow proceeds to assigning one or more non-terminals to one or more of the one or more terminals, wherein the non-terminals belong to a grammar and are stored in a symbol table (BLOCK 202). In an embodiment, HLEX 12 is configured for the grammar to assign non-terminals to the terminals. The flow proceeds to reducing the one or more non-terminals to one or more reduced non-terminals symbols based on a set of reduction rules (BLOCK 204). In an embodiment, the reduction subsystem 18 reduces the non-terminal symbols based on a set of reduction rules. In an embodiment, the reduction subsystem 18 uses a reduction stack 68 to expand the set of grammars that can be implemented by the phrase processor system 10. The flow proceeds to producing one or more leaf non-terminals based on at least one of the one or more reduced non-terminals and a set of production rules (BLOCK 206). In an embodiment, production subsystem 24, uses a production stack 88 to expand the set of grammars that the phrase processor 10 can implement. The flow proceeds to generating actions and data as a result of the actions based on the production rules used to produce the one or more leaf non-terminals and based on the delineation of the received string (BLOCK 208). In an embodiment, the production subsystem 24 uses a copy of the symbol table exchange structure 26 and the production rules to perform routing. In an embodiment, there are further control lines attached to the terminal string generator 90, and in an embodiment the terminal out FIFO 28 may have further controls to interpret symbols written to the terminal out FIFO 28. The flow optionally proceeds to assigning unknown non-terminals to unknown delineations of the received string and matching unrecognized non-terminals with non-terminals based on inferences determinable from the reduction rules and based on the contents of the string corresponding to the unrecognized non-terminals. In an embodiment, the reduction subsystem 18 uses a reduction stack 68 to permit inferences of identifying unknown non-terminals.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed is:

1. A phrase processor system defining a set of grammars for implementing one or more applications for data processing, comprising:
a grammar being implemented by the phrase processor system, comprising non-terminals, reserved words, tokens, reserved strings, reduction rules, and production rules;
a hardware lexical scanner (HLEX), arranged to execute the grammar, for receiving at least one string comprising at least one token and assigning one or more parts of the string to at least one token, and for assigning one or more of the assigned at least one token to non-terminals based on at least one of: the relative position of the token in the received string, a reserved word, or a reserved string;
a symbol table exchange structure configured for receiving the non-terminal symbols from the HLEX and arranged to be able to simultaneously receive and transmit symbols;
a reduction subsystem, arranged to execute the grammar, connected with the symbol table exchange structure and configured to receive one or more symbol table entries and produce reduced non-terminal symbols based on a set of reduction rules, wherein the size of the received symbol table entry is proportional to the number of symbols of the grammar; and
a production subsystem, arranged to execute the grammar, operatively connected with the reduction subsystem and the symbol table exchange structure and configured to receive reduced non-terminal symbols from the reduction subsystem, and produce one or more non-terminal symbols directly correlated to one or more terminals, and further arranged to produce actions based on the non-terminal symbols and the production rules, and to transmit processed structured data to a terminal output.

2. A phrase processor as claimed in claim 1, wherein the grammar further comprises one or more unrecognized non-terminals, and the HLEX is further configured to assign an unrecognized part of the at least one string to one or more unrecognized non-terminals, and the reduction subsystem is further configured to match the one or more unrecognized non-terminals to at least one non-terminal based on inferences determined based on the reduction rules.

3. A phrase processor as claimed in claim 2, wherein the reduction subsystem is further configured to match the one or more unrecognized non-terminals with at least one non-terminal based on inferences determined based on the reduction rules and based on the contents of the string corresponding to the one or more unrecognized non-terminals.

4. A phrase processor as claimed in claim 3, wherein the reduction subsystem is further configured to use the assistance of a reduction stack to match the one or more unrecognized non-terminals to at least one non-terminal.

5. A phrase processor as claimed in claim 4, wherein the production subsystem further comprising an associative memory capable of comprising production rules encoded therein.

6. A phrase processor as claimed in claim 5, wherein the production subsystem further comprises reduction state machine arranged to execute the grammar, comprising an encoding of a finite state machine to recognize the grammar.

7. A phrase processor as claimed in claim 1, wherein the grammar comprises conditions evaluated by the reduction subsystem, wherein the reduction subsystem is arranged to select from a predetermined set of non-terminals based on the evaluation of the condition.

8. A phrase processor as claimed in claim 7, wherein the reduction subsystem further comprises a connection set attribute memory for maintaining a context between received strings, wherein the context is maintained by the value assigned to symbols of the grammar.

9. A phrase processor as claimed in claim 8, wherein the reduction subsystem further comprises a set table associative memory arranged to identify whether a non-terminal is a member of a class defined by the grammar.

10. A phrase processor as claimed in claim 1, wherein the phrase processor system is implemented on a chip, wherein the reduction subsystem is controlled by a cycle of matching one or more non-terminals to a first associative memory encoded with the reduction rules of the grammar and the production subsystem is controlled by a cycle of matching one or more non-terminals to a second associative memory encoded with the production rules of the grammar, and wherein the two cycles may operate independently.

11. A phrase processor as claimed in claim 1, wherein the grammar of the phrase processor system executes a routing application.

12. The phrase processor as claimed in claim 1, wherein the symbol table exchange structure comprises associative memory.

13. The phrase processor as claimed in claim 1, wherein the production subsystem further comprises a production stack, and a sentential stack arranged to aid in matching production rules.

14. A phrase processor as claimed in claim 1 configured to perform the data processing application of processing message formats and/or frames.

15. A phrase processor as claimed in claim 6, wherein the phrase processor system is implemented on a chip.

16. A phrase processor as claimed in claim 1, wherein the production rules are deterministic.

17. A phrase processor as claimed in claim 1, further comprising a buffer for the HLEX to receive the string.

18. A method of implementing a grammar in hardware processing, comprising:
determining a delineation of one or more terminals in a received string;
assigning one or more non-terminals to one or more of the one or more terminals, wherein the non-terminals belong to a grammar and are stored in a symbol table;
reducing the one or more non-terminals to one or more reduced non-terminals symbols based on a set of reduction rules;
producing one or more leaf non-terminals based on at least one of the one or more reduced non-terminals and a set of production rules; and
generating actions and data as a result of the actions based on the production rules used to produce the one or more leaf non-terminals and based on the delineation of the received string.

19. The method of claim 18, further comprising:
assigning unknown non-terminals to unknown delineations of the received string; and
matching one or more unrecognized non-terminals with one or more non-terminals based on inferences determinable from the set of reduction rules and based on the contents of the string corresponding to the one or more unrecognized non-terminals.

20. A memory or a computer-readable medium storing instructions which, when executed by a processor, cause the processor to perform the method of
determining a delineation of one or more terminals in a received string;
assigning one or more non-terminals to one or more of the one or more terminals, wherein the one or more non-terminals belong to a grammar and are stored in a symbol table;
reducing the one or more non-terminals to one or more reduced non-terminals symbols based on a set of reduction rules;
producing one or more leaf non-terminals based on at least one of the one or more reduced non-terminals and a set of production rules; and
generating actions and data as a result of the actions based on the production rules used to produce the one or more leaf non-terminals and based on the delineation of the received string.
